(19) United States
(12) Patent Application Publication
(10) Pub. No.: US 2010/0297381 A1
(43) Pub. Date: Nov. 25, 2010

(54) Method of improving read stability of optical recording medium and optical recording medium manufactured using the method

(75) Inventors: Han-Feng Chang, Taoyuan County (TW); Yuh-Rur Kuo, Taoyuan County (TW); Yung-Hui Hung, Taoyuan County (TW); Kun-Long Li, Taoyuan County (TW); Shih-Hsien Ma, Taoyuan County (TW); Pang-Chi Liu, Taoyuan County (TW); Chin-Yen Yeh, Taoyuan County (TW); Kuan-Lan Fang, Taoyuan County (TW)

Correspondence Address: BACON & THOMAS, PLLC, 625 SLATERS LANE, FOURTH FLOOR, ALEXANDRIA, VA, 22314-1176, US

(73) Assignee: CMC Magnetics Corporation, Taipei (TW)

(21) Appl. No.: 12/453,790

(22) Filed: May 22, 2009

(51) Int. Cl. B32B 3/02; G11B 27/36

(52) U.S. Cl. 428/64.4; 369/53.41

(57) ABSTRACT

A method for improving read stability of optical recording medium is disclosed. In the method, the thickness of a recording layer of an optical recording medium is adjusted to control the disc absorptivity, and the recording layer thickness is matched with a power difference between a laser write power (Pw) and a laser erase power (Pe), so as to control the optimal laser power for irradiating and accordingly changing the optical properties of the recording layer. It is found that by using properly increased recording layer thickness corresponding to a given disc absorptivity, and properly matching the recording layer thickness with a properly increased power difference, the read stability and recording characteristics of the optical recording media can be improved without significantly changing the layer structure and writing strategy of the optical recording medium.

### FIELD OF THE INVENTION

The present invention relates to a method of improving read stability of optical recording medium, and more particularly to a method that improves the read stability of an optical recording medium through adjusting the recording layer thickness and controlling the erase/write power ratio without the need of significantly changing the layer structure and writing strategy of the optical recording medium. The present invention also relates to an optical recording medium manufactured using the method.

### BACKGROUND OF THE INVENTION

By “optical information storage”, it means the storage of data on an optical recording medium using laser technology. That is, focused laser beam is used to change the material structure of a recording layer of an optical disc to thereby result in obvious difference in the reflectivity at positions with different structures. Based on this principle, signals 0 and 1 are recorded and read. Optical recording medium can be generally divided into two types, namely, write-once medium and rewritable medium. In the rewritable medium, the phase change material for the recording layer, when being irradiated by laser of different intensities, will form crystalline phase structure or amorphous phase structure; and the function of repeatedly reading and writing the medium can be achieved by utilizing the reversible phase change between the crystalline phase and the amorphous phase.

To store a signal on a phase change disc, a recording mark is created by irradiating a short-pulse laser having a relatively high power on the recording layer of the disc. The power of the short-pulse laser is also referred to as a write power Pw. The irradiated region of the recording layer is heated and the temperature thereof rapidly rises to become higher than the melting point of the material for forming the recording layer. At this point, due to the heat dissipation design for the layer structure of the disc and the quickly spinning disc, the molten region quickly cools again. Therefore, atoms in this region do not have sufficient time to move to a stable crystalline lattice position to form an amorphous phase having relatively low reflectivity. The amorphous region and the surrounding crystalline region have different optical characteristics to form contrast in reflectivity.

To erase the recording mark, a long-pulse laser having a somewhat lower power is irradiated on the region with the recording mark. The power of the long-pulse laser is also referred to as an erase power Pe. The irradiated region is heated and the temperature thereof rises to become higher than the crystallization temperature but lower than the melting point of the material of the recording layer. Since the region is irradiated by longer laser pulse duration, atoms in this region have sufficient time and energy to move into a relatively stable state, and the region will form a crystalline phase with relatively higher reflectivity, and the original recording mark is erased. When the crystalline phase with higher reflectivity is represented by “0” and the amorphous phase with lower reflectivity is represented by “1”, digital data of 0 and 1 can be recorded on the disc.

To read the data recorded on the phase change disc, a laser with an even lower read power is irradiated on the recording layer of the disc. Since the crystalline phase and the amorphous phase are different in reflectivity, a relatively lower laser power can be used to detect changes in the intensity of light reflected from different regions, so as to read the recorded digital data.

Therefore, when using laser to irradiate the recording layer, it is able to create a new recording mark on the recording layer and erase the old recording mark to achieve the function of direct overwrite by modulating the write power Pw, the erase power Pe, and a basic power Pb to different levels and controlling the irradiation durations.

The quality of the recording mark can be evaluated according to a jitter value. When a recording mark is created on the recording layer by irradiating the recording layer with laser, the region with the recording mark and the region without the recording mark are obviously different in the reflectivity thereof to thereby form the digital data of 0 and 1. The recording mark has a leading end, from where the signal changes from 0 to 1, and a tail end, from where the signal changes from 1 to 0. When detecting the boundary timing of the leading end and the tail end of the recording mark and setting the boundary timing to be an edge signal, a time variation between the time pulse T of the edge signal and the reproduced signal is referred to as a “jitter value”. For a Blue-ray disc-Rewritable (BD-RE), the recording linear velocity at 1× is 4.92m/s, and the reference time pulse T is 15.15 nanoseconds.

In a recording mechanism based on a phase change optical recording medium, when it is desired to effectuate recording at very high speed, the material for the recording layer must have a high crystallization rate to enable complete erasing of the old signal when the disc spins at high speed and to achieve the purpose of direct overwrite at high speed. The crystallization rate has relation with the nature of the recording layer material. However, when a recording layer material with a high crystallization rate is selected only for increasing the recording speed without taking other factors into consideration, the recording mark tends to gradually deform or even disappear with time when the recording medium is stored under a high-temperature environment on a long-term basis. Meanwhile, the region without the recording mark also tends to have change in its crystalline state to result in deteriorated overwrite characteristic. At this point, the layer structure and the writing strategy for the recording medium must be adjusted in order to control the dissipation of heat produced after the optical recording medium is irradiated using laser. That is, while sufficient laser energy must be irradiated on the recording medium to create signals that can be successfully read, heat produced when the recording medium is irradiated with laser must be quickly dissipated from the recording medium to avoid a second time deterioration of the recording layer material due to excessively accumulated heat. Moreover, with a recording layer material having high crystallization rate, it is possible the recording layer molten at the time of writing signal using laser could not quickly cool to create a long enough mark. Under this situation, it would be difficult to control the recording mark to have a specific length, and accordingly, particularly uneasy to correctly create a recording mark that corresponds to a relatively short reference time pulse T.

Different recording layer materials are different in the easiness of forming the amorphous phase, as well as in the crystallization rate. When a particular recording layer material is employed, there is an optimal recording linear velocity and an optimal range of applicable laser power for that particular recording layer material. Generally speaking, when the recording linear velocity is high, a write power with higher energy must be used to create the recording mark within a shorter time. Therefore, write power and erase power often increase with the increasing of the recording linear velocity. As a result, the levels of the write power and the erase power as well as the erase/write power ratio have very important influences on the formation of a perfect recording mark.

Taiwan Invention Patent No. I289723 discloses a phase change recording medium, in which a peak power, a basic power, and an erase power are adjusted to control the power of the irradiating laser, and parameter such as an erase/peak power ratio is changed, in order to find the optimal recording linear velocity; meanwhile, the recording/erase power ratio is changed at specific intervals, so that the recording medium has uniform and good recording characteristics from inner to outer turns. However, the above patented invention does not mention the influence of the described power adjustments on the read stability of the recording medium. It is known that there are times when a recording medium shows good recording characteristics, such as low jitter value, when the signals are first written onto the recording medium. However, in the event the recording medium is not properly designed in terms of its layer structure and recording parameters, the recording marks thereon will change and the recorded data will lose after the recording medium has been repeatedly read for many times to have a large amount of heat accumulated in the recording layer.

It is therefore tried by the inventors to develop a method of improving read stability of optical recording medium and to provide an optical recording medium manufactured using the method to thereby have good read stability even when the recording medium has been repeatedly read for many times.

### SUMMARY OF THE INVENTION

A primary object of the present invention is to provide an optical recording method, which utilizes the relation between the disc absorptivity and the disc layer structure to control proper write power and erase power, and utilizes good match of the write power with the erase power to improve the read stability of the optical recording medium. The main technical means adopted in the present invention is to properly increase the recording layer thickness and reduce the erase/write power ratio of an optical recording medium to improve the read stability thereof.

Another object of the present invention is to provide an optical recording medium with improved read stability using the above-mentioned optical recording method.

To achieve the above and other objects, the method of improving read stability of optical recording medium according to the present invention includes the step of adjusting the laser absorptivity of the optical recording medium by changing the thickness of a recording layer of the recording medium; at a given laser absorptivity, setting at least one of an erase/write power (Pe/Pw) ratio, a write power, and an erase power to be variable; based on a premise of not to significantly change a jitter value measured at the time signals are first written onto the recording medium, gradually reducing the erase/write power ratio according to the given laser absorptivity; or alternatively, gradually increasing the laser absorptivity of the recording medium, which does not include a reflective layer, and then gradually reducing the erase/write power ratio; and evaluating the read stability of the recording signals by measuring and observing whether the jitter value rapidly increases after the recording signals are continuously read for one million times.

In the optical recording method for recording data on a rewritable optical recording medium according to the present invention, a laser beam can be irradiated on a substrate side of the recording medium to write or read data. Or, alternatively, the laser beam can be irradiated on the other side of the recording medium opposite to the substrate thereof, provided a layer structure above the substrate of the recording medium has been correspondingly adjusted.

The layer structure above the substrate includes at least a reflective layer, a recording layer, a protective layer, and a light transmitting layer. In the case the layer structure constructed on the substrate includes a first protective layer formed on the substrate, a recording layer formed on the first protectively layer, a second protective layer formed on the recording layer, a second interface layer formed on the second protective layer, a reflective layer formed on the second interface layer, and a light transmitting layer formed on a top of the layer structure, the laser beam can be irradiated from the substrate side of the optical recording medium to write and read data.

In the case the layer structure constructed on the substrate is adjusted to have a reflective layer formed on the substrate, a first interface layer formed on the reflective layer, a first protective layer formed on the first interface layer, a recording layer formed on the first protective layer, a second protective layer formed on the recording layer, a second interface layer formed on the second protective layer, and a light transmitting layer formed on the top of the layer structure, the laser beam can be irradiated from the other side of the optical recording medium opposite to the substrate to write and read data.

When the optical recording medium is manufactured using the method of improving read stability of optical recording medium according to the present invention, intensity of signals recorded on the optical recording medium would not become weak or disappeared even if the recording medium has been repeatedly read for many times. Therefore, data stored on the recording medium can be stably stored over a long period of time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic cross-sectional view showing the layer structure of an optical recording medium according to a preferred embodiment of the present invention;

FIG. 2 shows dynamic test results of a disc prepared according to a first experimental example of the present invention after the disc has been continuously directly overwritten for ten times using a write power in the range of 4.80 mW to 6.33 mW and an erase/write power (Pe/Pw) ratio lower than 0.65;

FIG. 3 shows dynamic test results of the relationship between times of read and jitter value of a disc prepared according to the first experimental example of the present invention, after recording signals having periods two to eight times as long as a reference time pulse T have been written on the disc using a write power of 5.5 mW and an erase power of 3.6 mW, and accordingly, a power difference of 1.9 between the write and the erase power;

FIG. 4 shows changes in the disc absorptivity of discs prepared according to the first experimental example and having different recording layer thicknesses, after a reflective layer is omitted from the disc layer structure;

FIG. 5 shows dynamic test results of the relationship between times of read and jitter value of a disc prepared according to a second experimental example of the present invention, after recording signals having periods two to eight times as long as a reference time pulse T have been written on the disc using a write power of 5.7 mW and an erase power of 3.6 mW, and accordingly, a power difference of 2.1 between the write and the erase power; and

FIG. 6 shows dynamic test results of the relationship between times of read and jitter value of a disc prepared according to a third experimental example of the present invention, after recording signals having periods two to eight times as long as a reference time pulse T have been written on the disc using a write power of 5.9 mW and an erase power of 3.4 mW, and accordingly, a power difference of 2.5 between the write and the erase power.

### DETAILED DESCRIPTION OF THE PREFERRED EMBODIMENTS

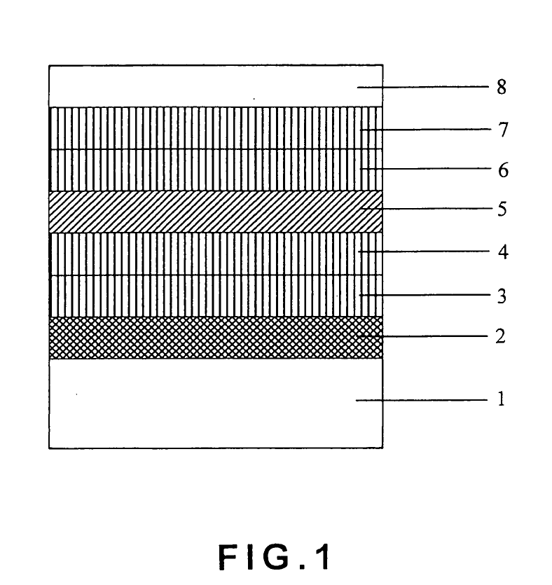

Please refer to FIG. 1 that is a schematic cross-sectional view showing a layer structure for an optical recording medium according to a preferred embodiment of the present invention. As shown, the optical recording medium includes a substrate 1, a reflective layer 2, a first interface layer 3, a first protective layer 4, a recording layer 5, a second protective layer 6, a second interface layer 7, and a light transmitting layer 8 arranged from bottom to top. The substrate 1 is made of a material with optical transparency and providing suitable mechanical strength for the optical recording medium. The material for the substrate 1 of the optical recording medium of the present invention can include, but not limited to, polycarbonate resin, polymethyl methacrylate, polystyrene resin, polyethylene resin, and polypropylene resin. The substrate I is preformed on one surface with grooves and lands. These grooves and lands function as laser beam guide tracks and data recording positions during data recording or data reading.

The first interface layer 3 and the second interface layer 7 are made of a material selected from the group consisting of metal nitrides and metal oxides. The metal nitrides can include, for example, silicon nitride (Si₃N₄), germanium nitride (GeN), titanium nitride (TiN), niobium pentoxide (Nb₂O₅), and silicon-oxygen-nitride (Si—O—N). And, the metal oxides can include, for example, silicon dioxide (SiO₂), aluminum oxide (Al₂O₃), and titanium dioxide (TiO₂). The first interface layer 3 and the second interface layer 7 respectively have a thickness ranged from 0 nm to 50 nm.

The first protective layer 4 and the second protective layer 6 are made of a material selected from the group consisting of metal oxides and metal nitride, such as zinc sulfide-silicon dioxide (ZnS—SiO₂), silicon nitride (SiN or Si₃N₄), germanium nitride (GeN), silicon carbide (SiC), silicon dioxide (SiO₂), aluminum oxide (Al₂O₃), and titanium dioxide (TiO₂). The first and the second protective layer 4, 6 can be made of any one of the above dielectric materials or any combination thereof, and each have a thickness ranged from 1 nm to 200 nm.

The reflective layer 2 can be made of an element selected from the group consisting of silver (Ag), gold (Au), aluminum (Al), molybdenum (Mo), tantalum (Ta), titanium (Ti), and any alloy thereof. And, the reflective layer 2 has a thickness ranged from 5 nm to 300 nm.

The recording layer 5 is made of a phase change material with high crystallization rate. The composition of the recording layer material can be adjusted in response to different requirements for recording linear velocity. According to an ideal embodiment of the present invention, the material composition for the recording layer 5 contains at least one of germanium (Ge), tin (Sn), antimony (Sb), tellurium (Te), gallium (Ga), and indium (In). Some applicable examples of the recording layer material composition include Ge—In—Sb—Te, Ge—Sb—Sn, In—Sb—Te, Ag—In—Sb—Te, Ge—In—Sb—Sn, Ga—In—Sb—Te, and Ga—In—Sb—Sn. For an application at BD 2× recording speed, the preferred recording layer material and the atomic percentages (at. %) of different compositions thereof are as follows: 0<Ge<10, 0<In<10, 50<Sb<70, and 20<Te<30. The recording layer 5 has a thickness ranged from 3 nm to 30 nm.

The light transmitting layer 8 can be made of an ultraviolet-curing (UV-curing) resin for protecting the materials for the layers of the optical recording medium against wearing, deterioration from moisture, or oxidation from exposure to air, so as to ensure the stability of the layers of the optical recording medium.

A method of improving read stability of optical recording medium according to the present invention will now be described in detail in connection with some experimental examples. The following experimental examples illustrate only the present invention, and the scope of the present invention is not limited by the following experimental examples.

### EXPERIMENTAL EXAMPLE 1

A Blue-ray disc-Rewritable (BD-RE) substrate 1 with grooves and lands formed on one surface thereof is prepared. The substrate 1 has a track pitch of 320 nm and a thickness of 1.1 mm. Then, using magnetic sputtering, a layer of silver (Ag) with a thickness of 100 nm is formed on the substrate 1 to serve as a reflective layer 2, a layer of SiN with a thickness of 8 nm is formed on the reflective layer 2 to serve as a first interface layer 3, a layer of ZnS—SiO₂ with a thickness of 8 nm is formed on the first interface layer 3 to serve as a first protective layer 4, a recording layer 5 with a thickness of 11 nm is formed on the first protective layer 4, a layer of ZnS—SiO₂ with a thickness of 19 nm is formed on the recording layer 5 to serve as a second protective layer 6, and a layer of SiN with a thickness of 30 nm is formed on the second protective layer 6 to serve as a second interface layer 7 to obtain a layer structure as that shown in FIG. 1. Finally, a light-transmitting film with a thickness of 0.1 mm is spin-coated on the second protective layer 6 to serve as a light transmitting layer 8 to complete a disc according to the experimental example 1.

The thicknesses of the layers formed using magnetic sputtering are observed using an atomic force microscope (AFM) and an optical measuring apparatus (Eta Optik). The prepared disc is subjected to a dynamic analysis, in which a Pulstec ODU-1000 dynamic tester is used to measure dynamic characteristics of the disc. During the dynamic analysis, the dynamic tester uses a write power ranged from 5.5 mW to 5.9 mW, a read power of 0.35 mW, a laser wavelength (λ) of 405 nm, a numerical aperture (NA) of 0.85, and two different writing linear velocities of 4.92 m/s and 9.84 m/s respectively corresponding to the BD-RE 1× and 2× recording speed.

When write in signals using laser, the recording layer is heated by the laser pulse to thereby have rising temperature. In the case the write power is too low, the temperature of the recording layer 5 is not heated to a temperature high enough to produce any change in the reflectivity of the thin film thereof. As a result, it is not able to measure the jitter value and modulation value. On the other hand, in the case the write power is too high, the jitter value will increase with the increasing write power. A reason for this condition might be that the high laser power overheats the recording layer 5 to cause deformation of the disc layer structure and accordingly increased jitter value. Therefore, as a known general principle, a compact disc can only adapt to a write power fallen within a predetermined range.

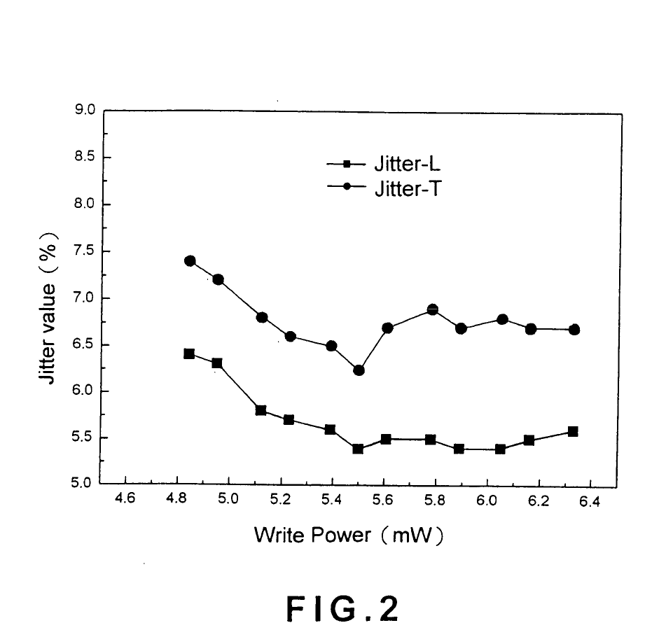

FIG. 2 shows dynamic test results of a disc prepared according to the experimental example 1 after the disc has been continuously directly overwritten for ten times using a write power in the range of 4.80 mW to 6.33 mW and an erase/write power (Pe/Pw) ratio lower than 0.65. As can be seen from the test results, the jitter value decreases to its lowest value, including a jitter value of 5.39 at a leading end of the recording mark (jitter-L) and a jitter value of 6.24 at a tail end of the recording mark (jitter-T), as the write power increases from 4.8 mW to 5.5 mW. This indicates the preferred write power is 5.5 mW. The jitter value gradually increases when the write power is higher than 5.5 mW or lower than 5.5 mW. However, when a deviation of the write power from the optimal write power is within ±10%, the jitter value can still be maintained below 7.0, which still satisfies the specification of the BD-RE.

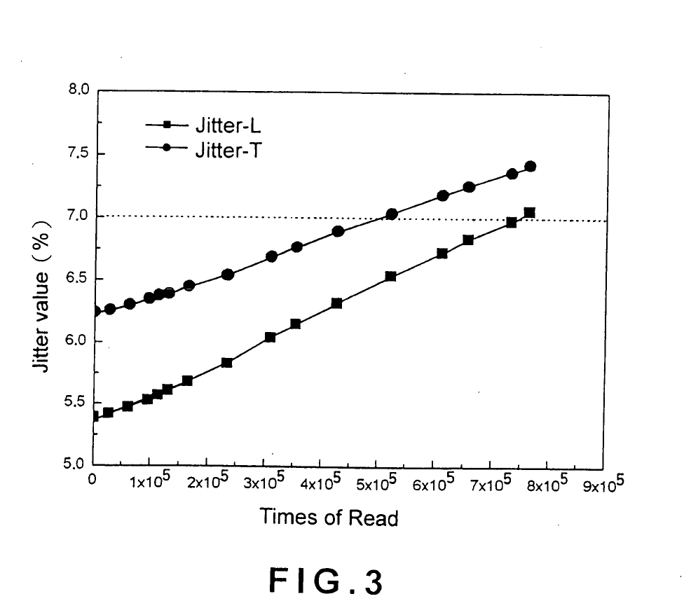

Although relatively small jitter values of the disc prepared according to the experimental example 1 are measured after the disc has been continuously directly overwritten for ten times, read stability of the disc after having been read over a long period of time is further tested. FIG. 3 shows dynamic test results of the relationship between times of read and jitter value of the disc prepared according to the experimental example 1, after recording signals having periods two to eight times as long as a reference time pulse T have been written on the disc using a write power of 5.5 mW and an erase power of 3.6 mW, and accordingly, a power difference of 1.9 between the write and the erase power (Pw-Pe=1.9). As can be seen from the test results in FIG. 3, the jitter-L and the jitter-T are 5.39 and 6.24, respectively, when the recording medium is used to record signals thereon for the first time. However, the jitter values of the disc increase with the times of read when the signals are continuously read with a read power of 0.35 mW at room temperature. The jitter-L and the jitter-T increase to 7.06 and 7.43, respectively, when the signals are continuously read for 760,000 times, indicating the recording marks have obviously deteriorated after the disc is continuously read many times with a low read power. That is why the recording signals could not be stably stored over a long time.

According to the method of the present invention, the deterioration of recording signals can be improved by controlling the disc absorptivity of laser at a given wavelength through adjustment of the thickness of the recording layer 5. It is found the deterioration of recording signals is improved when the thickness of the recording layer 5 and the power difference between the write power and the erase power (Pw-Pe) are correspondingly increased.

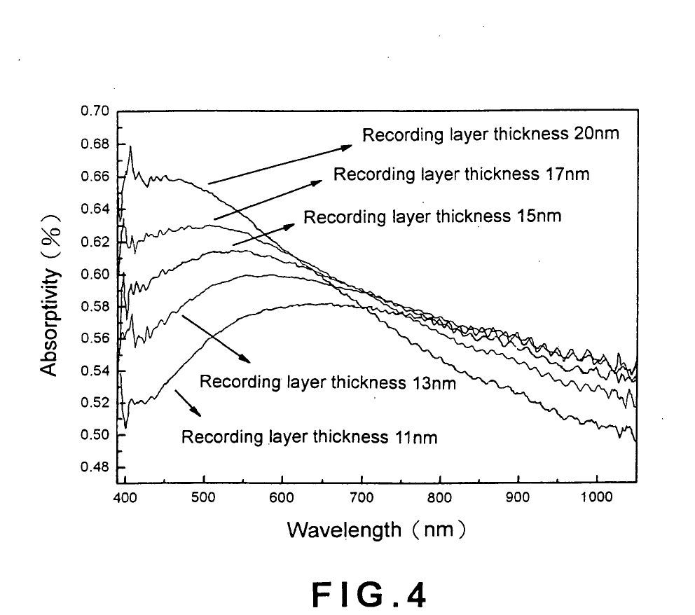

FIG. 4 shows the relation between the thickness of the recording layer 5 and the disc absorptivity of the disc layer structure prepared according to the experimental example 1 with the reflective layer omitted therefrom to avoid influence by reflected signals. As can be seen from FIG. 4, when the recording medium without the reflective layer has a recording layer 5 with a thickness of 11 nm, that is, the same as that in the experimental example 1, and is irradiated by 405 nm blue-light laser, the disc absorptivity is 52%. With all other layers of the recording medium kept unchanged, the recording medium irradiated by 405 nm blue-light laser has a disc absorptivity of about 57% when the thickness of the recording layer 5 is increased to 13 nm; a disc absorptivity of about 59% when the thickness of the recording layer 5 is increased to 15 nm; a disc absorptivity of about 62% when the thick ness of the recording layer 5 is increased to 17 nm; and a disc absorptivity of about 68% when the thick ness of the recording layer 5 is further increased to 20 nm. As can be found from the above results, the disc absorptivity increases with the increase of the thickness of the recording layer 5. Since both an excessively low and an excessively high absorptivity have adverse influences on the absorption of laser energy by the recording layer 5 and accordingly, cause adverse changes in the optical properties of the recording layer 5, a disc with excessively low or excessively high absorptivity would have reduced recording sensitivity. Therefore, under given recording conditions, the recording medium must have disc absorptivity within a predetermined range, and the thickness of the recording layer 5 is the main factor that affects the disc absorptivity.

To prove the influence of different recording layer thicknesses and correspondingly matching power difference between write power and erase power (Pw-Pe) on the read stability of the recording signals, an optical recording medium with changed recording layer thickness and power difference between the write power and the erase power is prepared as in the following experimental example 2.

### EXPERIMENTAL EXAMPLE 2

A Blue-ray disc-Rewritable (BD-RE) substrate with grooves and lands formed on one surface thereof is prepared. The substrate has a track pitch of 74 μm and a thickness of 1.1 mm. Then, using magnetic sputtering, a layer of silver (Ag) with a thickness of 100 nm is formed on the substrate to serve as a reflective layer 2, a layer of SiN with a thickness of 8 nm is formed on the reflective layer 2 to serve as a first interface layer 3, a layer of ZnS—SiO₂ with a thickness of 8 nm is formed on the first interface layer 3 to serve as a first protective layer 4, a recording layer 5 with a thickness of 13 nm is formed on the first protective layer 4, a layer of ZnS—SiO₂ with a thickness of 19 nm is formed on the recording layer 5 to serve as a second protective layer 6, and a layer of SiN with a thickness of 30 nm is formed on the second protective layer 6 to serve as a second interface layer 7. Finally, a light-transmitting film with a thickness of 0.1 mm is spin-coated on the second protective layer 6 to serve as a light transmitting layer 8 to complete a disc according to the experimental example 2.

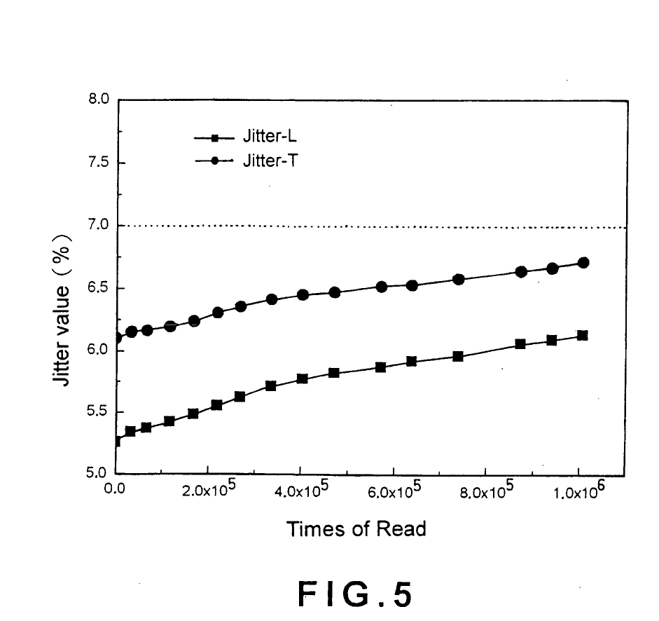

FIG. 5 shows dynamic test results of the relationship between times of read and jitter value of the disc prepared according to the experimental example 2, after recording signals having periods two to eight times as long as a reference clock T have been written on the disc using a write power of 5.7 mW and an erase power of 3.6 mW, and accordingly, a power difference of 2.1 between the write and the erase power (Pw-Pe=2.1). As can be seen from the test results in FIG. 5, the jitter-L and the jitter-T are 5.26 and 6.10, respectively, when the recording medium is used to record signals thereon for the first time. However, the jitter values of the disc increase with the times of read when the signals are continuously read with a read power of 0.35 mW at room temperature. The jitter-L and the jitter-T increase to 6.13 and 6.71, respectively, when the signals are continuously read for 1,006,000 times, indicating the recording marks have deteriorated after the disc is continuously read many times with a low read power. However, the jitter values are still maintained below 7.0, indicating the deterioration of the recording marks after being read many times has been improved when the thickness of the recording layer is increased and the value of Pw-Pe is correspondingly increased to match with the increased recording layer thickness.

The following experimental example 3 studies the application of an optical recording medium with further increased recording layer thickness and the corresponding disc absorptivity thereof.

### EXPERIMENTAL EXAMPLE 3

A Blue-ray disc-Rewritable (BD-RE) substrate with grooves and lands formed on one surface thereof is prepared. The substrate has a track pitch of 74 μm and a thickness of 1.1 mm. Then, using magnetic sputtering, a layer of silver (Ag) with a thickness of 100 nm is formed on the substrate to serve as a reflective layer 2, a layer of SiN with a thickness of 8 nm is formed on the reflective layer 2 to serve as a first interface layer 3, a layer of ZnS—SiO₂ with a thickness of 8 nm is formed on the first interface layer 3 to serve as a first protective layer 4, a recording layer 5 with a thickness of 15 nm is formed on the first protective layer 4, a layer of ZnS—SiO₂ with a thickness of 19 nm is formed on the recording layer 5 to serve as a second protective layer 6, and a layer of SiN with a thickness of 30 nm is formed on the second protective layer 6 to serve as a second interface layer 7. Finally, a light-transmitting film with a thickness of 0.1 mm is spin-coated on the second protective layer 6 to serve as a light transmitting layer 8 to complete a disc according to the experimental example 3.

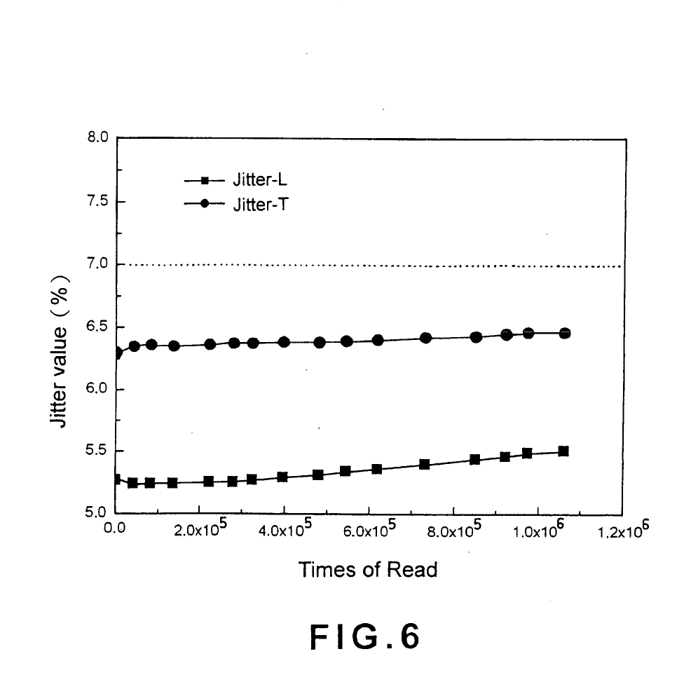

FIG. 6 shows dynamic test results of the relationship between times of read and jitter value of the disc prepared according to the experimental example 3, after recording signals having periods two to eight times as long as a reference time pulse T have been written on the disc using a write power of 5.9 mW and an erase power of 3.4 mW, and accordingly, a power difference of 2.5 between the write and the erase power (Pw-Pe=2.5). As can be seen from the test results in FIG. 6, the jitter-L and the jitter-T are 5.27 and 6.29, respectively, when the recording medium is used to record signals thereon for the first time. However, the jitter values of the disc increase with the times of read when the signals are continuously read with a read power of 0.35 mW at room temperature. The jitter-L and the jitter-T increase to 5.51 and 6.46, respectively, when the signals are continuously read for 1,061,000 times, indicating the jitter values increase slightly after the recording marks are continuously read many times with a low read power. However, the jitter values are still maintained below 6.5, indicating the deterioration of the recording marks after being read many times has been significantly improved when the thickness of the recording layer is increased and the value of Pw-Pe is correspondingly increased to match with the increased recording layer thickness. That is, the recording signals do not deteriorate due to being read many times with a read power.

It is found the disc absorptivity correspondingly increases to 68% when the thickness of the recording medium 5 is further increased to 20 nm. Since the disc absorptivity of 68% is too high for the current layer structure, change in the sensitivity of the recording layer 5 to laser will occur, and recording marks could no longer be successfully written on the current disc layer structure using laser.

The above experimental examples 1 to 3 describe the method of improving read stability of optical recording medium according to the present invention. In the method, by controlling the disc absorptivity to range from 52% to 59% and increasing the power difference (Pw-Pe) from 1.9 to 2.5, the read stability of the recording media can be improved without changing or without the need of significantly changing the layer structure and the writing strategy of the recording medium. More specifically, in the method of improving read stability of optical recording medium according to the present invention, the power difference between the write power and the erase power is adjusted and the adjusted power difference is properly matched with the disc absorptivity. To match with relatively larger disc absorptivity, the power difference between the write power and the erase power should be relatively increased, as shown in Table 1. At a BD-RE 1× writing speed, the power difference (Pw-Pe) should be ranged from 2.1 to 2.6 when the disc absorptivity is 52%; from 2.2 to 2.7 when the disc absorptivity is 57%; from 2.3 to 2.8 when the disc absorptivity is 59%; and from 2.5 to 3.0 when the disc absorptivity is 62%.

TABLE 1

| Disc Absorptivity | Write Power-Erase Power |
|---|---|
| 52% | 2.1~2.6 |
| 57% | 2.2~2.7 |
| 59% | 2.3~2.8 |
| 62% | 2.5~3.0 |

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of improving read stability of optical recording medium, comprising the step of adjusting disc absorptivity of the recording medium by changing a thickness of a recording layer of the recording medium; at a given disc absorptivity, setting at least one of an erase/write power (Pe/Pw) ratio, a write power, and an erase power to be variable; based on a premise of not to significantly change a jitter value measured at the time signals are first written onto the recording medium, gradually reducing the erase/write power ratio according to the given disc absorptivity; or alternatively, gradually increasing the disc absorptivity and then gradually reducing the erase/write power ratio;
and evaluating the read stability of the optical recording signals by measuring and observing whether the jitter value rapidly increases after the recording signals are continuously read for one million times.

2. An optical recording medium, comprising a substrate, a reflective layer, at least one protective layer, a recording layer, at least one interface layer, and a light transmitting layer; the optical recording medium being characterized in that:
the protective layer prevents heat diffusion from occurring between the recording layer and the reflective layer when the recording layer is heated, provides proper thermal insulating effect, and has optical compensation effect;
the reflective layer is in contact with the interface layer to provide good optical reflecting effect and heat conduction; and
the interface layer controls the overall layer structure of the recording medium to have proper heat dissipation, overall absorptivity, and optical compensation during writing in signals.

3. The optical recording medium as claimed in claim 2, wherein data can be written onto and read from the optical recording medium by irradiating laser from one side of the recording medium opposite to the substrate, or alternatively, by irradiating laser from the substrate side when the layer structure of the recording medium has been correspondingly adjusted.

4. The optical recording medium as claimed in claim 2, wherein the recording layer has a thickness ranged from 3 nm to 30 nm.

5. The optical recording medium as claimed in claim 2, wherein the recording medium has a power difference between a write power and an erase power (Pw-Pe) ranged from 2.1 to 3.0 when the recording medium has a light absorptivity ranged from 52% to 70% after the reflective layer is removed.

6. The optical recording medium as claimed in claim 2, wherein the recording layer is made of a material selected from the group consisting of germanium (Ge), indium (In), antimony (Sb), tin (Sn), gallium (Ga), and tellurium (Te), and any combination thereof.

7. The optical recording medium as claimed in claim 2, wherein the at least one protective layer has a thickness rang ed from 1 nm to 200 nm, and is made of a dielectric material selected from the group consisting of zinc sulfide-silicon dioxide (ZnS—SiO₂), silicon nitride (SiN or Si₃N₄), germanium nitride (GeN), silicon carbide (SiC), silicon dioxide (SiO₂), aluminum oxide (Al₂O₃), and titanium dioxide (TiO₂), and any combination thereof.

8. The optical recording medium as claimed in claim 2, wherein the reflective layer is made of an element selected from the group consisting of gold (Au), silver (Ag), molybdenum (Mo), aluminum (Al), titanium (Ti), and tantalum (Ta), and any alloy thereof.

9. The optical recording medium as claimed in claim 2, wherein the light transmitting layer is an UV-curing resin.

10. The optical recording medium as claimed in claim 2, wherein the substrate can be a silicon substrate or made of a material with optical transparency and providing a predetermined mechanical strength for the optical recording medium, including, but not limited to, polycarbonate resin, polymethyl methacrylate, polystyrene resin, polyethylene resin, and polypropylene resin.

11. An optical recording medium, comprising a substrate, a reflective layer, a protective layer, an interface layer, a recording layer, and a light transmitting layer; the optical recording medium being characterized in that:
the protective layer prevents heat diffusion from occurring between the recording layer and the reflective layer when the recording layer is heated, provides proper thermal insulating effect, and has optical compensation effect; and
the reflective layer is in contact with the interface layer to provide good optical reflecting effect and heat conduction.

12. The optical recording medium as claimed in claim 11, wherein data can be 10 written onto and read from the optical recording medium by irradiating laser from one side of the recording medium opposite to the substrate, or alternatively, by irradiating laser from the substrate side when the layer structure of the recording medium has been correspondingly adjusted.

13. The optical recording medium as claimed in claim 11, wherein the recording layer has a thickness ranged from 3 nm to 30 nm.

14. The optical recording medium as claimed in claim 11, wherein the recording medium has a power difference between a write power and an erase power (Pw-Pe) ranged from 2.1 to 3.0 when the recording medium has a light absorptivity ranged from 52% to 70% after the reflective layer is removed.

15. The optical recording medium as claimed in claim 11, wherein the recording layer is made of a material selected from the group consisting of germanium (Ge), indium (In), antimony (Sb), tin (Sn), gallium (Ga), and tellurium (Te), and any combination thereof.

16. The optical recording medium as claimed in claim 11, wherein the protective layer has a thickness ranged from 1 nm to 200 nm, and is made of a dielectric material selected from the group consisting of zinc sulfide-silicon dioxide (ZnS—SiO₂), silicon nitride (SiN or Si₃N₄), germanium nitride (GeN), silicon carbide (SiC), silicon dioxide (SiO₂), aluminum oxide (Al₂O₃), and titanium dioxide (TiO₂), and any combination thereof.

17. The optical recording medium as claimed in claim 11, wherein the reflective layer is made of an element selected from the group consisting of gold (Au), silver (Ag), molybdenum (Mo), aluminum (Al), titanium (Ti), and tantalum (Ta), and any alloy thereof.

18. The optical recording medium as claimed in claim 11, wherein the light transmitting layer is an UV-curing resin.

19. The optical recording medium as claimed in claim 11, wherein the substrate can be a silicon substrate or made of a material with optical transparency and providing a predetermined mechanical strength for the optical recording medium, including, but not limited to, polycarbonate resin, polymethyl methacrylate, polystyrene resin, polyethylene resin, and polypropylene resin.
